(19) United States
(12) Patent Application Publication
(10) Pub. No.: US 2014/0051488 A1
(43) Pub. Date: Feb. 20, 2014

(54) SMARTPHONE CASE WITH CHARGE CARD POCKET AND STAND-UP SUPPORT FACILITY

(71) Applicant: MARWARE INC., Hollywood, FL (US)

(72) Inventor: CHANSEOL CHUNG, HOLLYWOOD, FL (US)

(73) Assignee: MARWARE INC., Hollywood, FL (US)

(21) Appl. No.: 13/970,153

(22) Filed: Aug. 19, 2013

Related U.S. Application Data
(60) Provisional application No. 61/684,478, filed on Aug. 17, 2012.

(51) Int. Cl. H04M 1/02

(52) U.S. Cl. CPC H04M 1/0279
USPC 455/575.8

(57) ABSTRACT

A smartphone case, or mobile telephone case, includes an upper part configured to at least partly cover a rear and sides of an upper portion of a mobile telephone and a lower part configured to at least partly cover a rear and sides of a lower portion of the smartphone. The case is formed with a pocket into which a card (e.g., a credit card, ID, etc.) may be placed for carrying and storage, and with a slot into which the card may be inserted so that the card becomes a support leg that supports the telephone similarly to a horizontal or vertical stand.

### CROSS-REFERENCE TO RELATED APPLICATION

This application claims the benefit, under 35 U.S.C. §119(e), of provisional patent application No. 61/684,478, filed Aug. 17, 2012. The prior application is herewith incorporated by reference.

### BACKGROUND OF THE INVENTION

1. Field of the Invention

The invention relates to a case for a mobile telephone, such as the iPhone® produced by Apple. The iPhone and other so-called smartphones combine a mobile telephone, digital multimedia player and camera and have a multi-touch screen with a virtual or actual keyboard and buttons as well as various ports, such as for charging, USB connection and ear bud connection.

2. Description of the Related Art

Mobile telephones have become indispensable items for large segments of the population. Therefore, the desire is to be able to use the mobile telephone during various activities, such as walking, jogging, working out, driving an automobile or riding a bicycle, etc. The mobile telephone also should be protected from shock and soiling. One of the great advantages of the smartphones is their ability to record and/or display videos and still images. Viewing the display is often difficult because it cannot easily be supported in a still position.

### BRIEF SUMMARY OF THE INVENTION

It is accordingly an object of the invention to provide a mobile telephone case, which overcomes various disadvantages of the prior art devices of this general type and which is versatile in its use and appearance while simultaneously protecting the mobile telephone from shock, damage and soiling. In addition, the device should be suitably useable in a variety of contexts and it should be supportable for viewing and/or recording.

With the foregoing and other objects in view there is provided, in accordance with the invention, a smartphone case, comprising:

an upper part configured to at least partly cover a rear and sides of an upper portion of a smartphone;

a lower part configured to at least partly cover a rear and sides of a lower portion of the smartphone and configured to connect to said upper part and, in an assembled condition together with said upper part, to form a protective case for the smartphone;

at least one of said parts defining a pocket dimensioned for receiving and housing a card having general dimensions of a credit card; and

at least one of said parts having a slot configured for partial insertion of the card in a direction substantially perpendicular to a rear wall of the smartphone.

In an earlier embodiment, there was provided, in accordance with the invention, a multipart mobile telephone case, comprising an upper part configured to at least partly cover a rear and sides of an upper portion of a mobile telephone, a lower part configured to at least partly cover a rear and sides of a lower portion of the mobile telephone and a center part configured to at least partly cover a rear and sides of a center portion of the mobile telephone. Locking mechanisms are each configured to lock the center part to a respective one of the upper and lower parts so as to cover the rear and sides of the mobile telephone in an assembled condition of the case. The case of the invention provides a simple structure, having only three primary parts, for reliably protecting a mobile phone from damage, shock and soiling, because the phone itself within the assembled case provides support for the parts of the case and maintains its integrity, without requiring complicated measures.

In addition, the device is provided with a pocket into which a card (e.g., a credit card, ID, etc.) may be placed for carrying and storage, and with a slot into which the card may be inserted. The novel mobile phone case allows the user to place their credit card or ID (i.e., up to two cards) in a corresponding pocket. The new case with the slot holds the card so that it becomes a horizontal or vertical stand.

In accordance with another feature of the invention, a front of the mobile telephone remains substantially exposed in the assembled condition of the case. This allows the user of the phone to access all of the touch screen features of the phone.

In accordance with a further feature of the invention, the locking mechanisms, which are preferably snap-locking mechanisms, include cooperating openings and detents. In one embodiment, the openings are formed in the upper and lower parts and the detents are formed on the center part, although the opposite can be the case as well. This structure provides a particularly robust snapping-together and locking of the parts.

Other features which are considered as characteristic for the invention are set forth in the appended claims.

Although the invention is illustrated and described herein as embodied in mobile telephone case with charge card pocket and stand-up support facility, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a front view of an exemplary embodiment of a mobile telephone case according to the invention;

FIG. 2 is right side view thereof;

FIG. 3 is a top view thereof;

FIG. 4 is a rear view thereof;

FIG. 5 is a bottom view thereof;

FIG. 6 is a left side view thereof;

FIG. 7 is a bottom rear perspective view thereof;

FIG. 8 is top rear perspective view thereof;

FIG. 9 is an exploded view of the case with a smartphone apparatus (iPhone® 5) in between the upper and lower parts;

FIG. 10 is a bottom perspective of the partly assembled case, with phone;

FIG. 11 is a top rear perspective, rotated about a vertical axis relative to FIG. 8, with the phone inserted;

FIG. 12 is a similar perspective view, including a charge card or ID card, just prior to its insertion into the card carry pocket;

FIG. 13 is a similar perspective view with the card inserted for storage and carry-along;

FIG. 14 is a rear perspective view illustrating a card in alignment just prior to prior to insertion for forming a standup support;

FIG. 15 is a front bottom perspective view of the assembled case with a smartphone and the stand-up facility, with the viewing screen in its landscape orientation;

FIG. 16 is a rear perspective view thereof;

FIG. 17 is a rear perspective view of the assembly, with the smartphone in its portrait orientation; and

FIG. 18 is a front perspective view thereof.

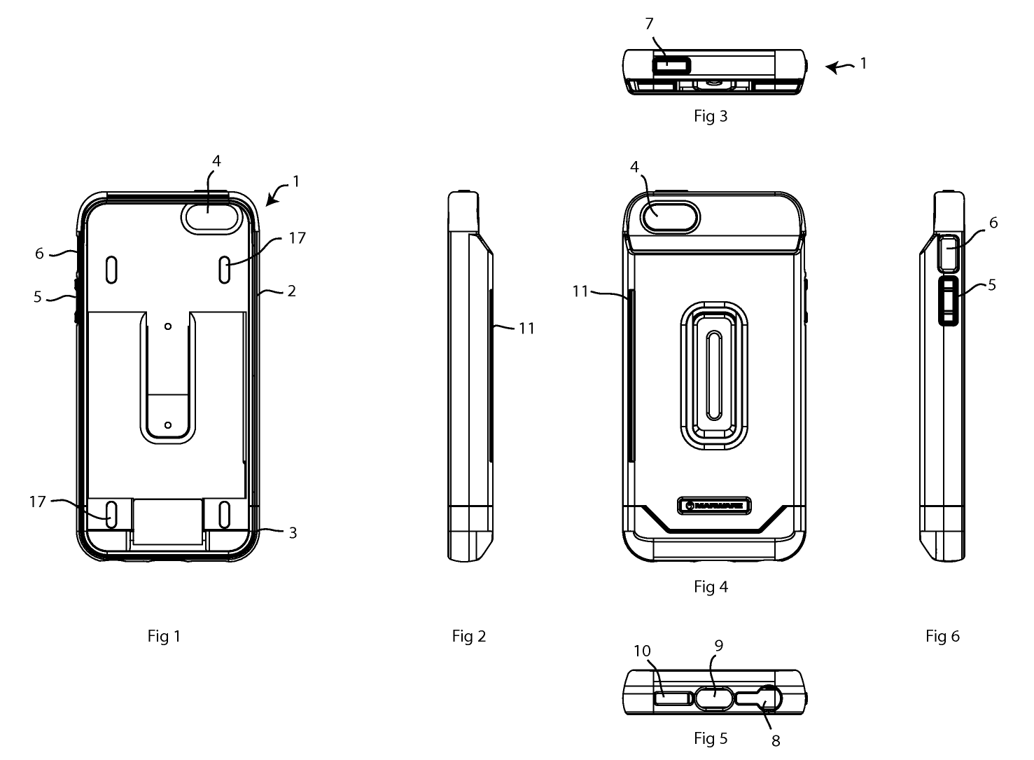

### DETAILED DESCRIPTION OF THE INVENTION

Referring now to the figures of the drawing in detail and first, particularly, to FIG. 1 thereof, there is shown a smartphone case 1. The case is shown, by way of example, for an iPhone® 5. It will be understood, of course, that the invention is equally applicable to other such devices, such as, for instance, any of the other iPhone models, the Galaxy® by Samsung, the Lumia® by Nokia, the HTC, the Droid Razr, to name just a few. The case 1 is formed primarily of two parts, namely, an upper part 2 and a lower part 3. As will become clear from the following description, the two parts 2 and 3 may be snapped together to form the case 1.

The case 1 has a substantially solid backwall formed with a cutout 4 through which the camera lens of the smartphone is exposed. The side frame if the case has a soft plastic toggle switch cover 5 for the volume buttons and an opening for the ringer on/off button 6. The top of the case 1 is formed with a soft plastic push button 7, which is aligned with the ON/OFF button of the phone.

The bottom of the case 1, that is, the lower part 3, is formed with three cutouts 8, 9, and 10, for data and energy supply connections. The upper part 2 of the case 1 is formed with a vertical slot 11, the significance of which will be described in the following. Also illustrated in FIG. 4 and some of the other views is a logo field 12 showing the logo of Marware, the assignee of this invention.

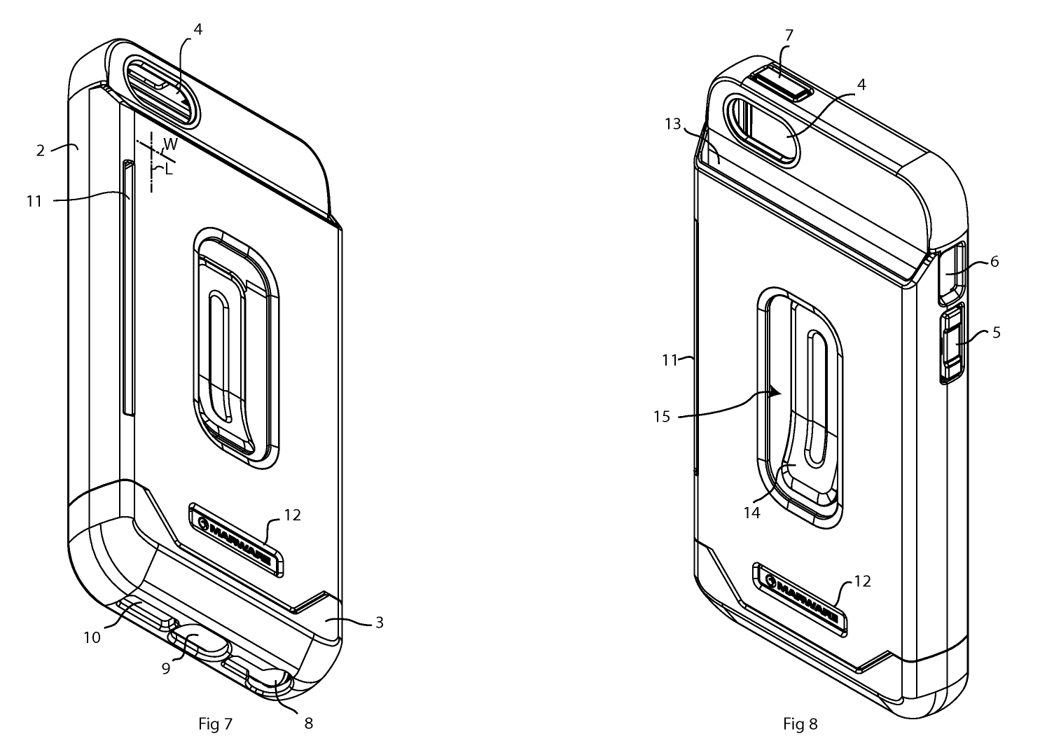

The perspective views of FIGS. 7 and 8 illustrate each of these parts in slightly more dimensional detail. The slot 11, and a pocket 13, infra, are dimensioned with a view to the “general dimensions of a credit card.” That is: the slot 11 is shown to be dimensioned with a given width (its open horizontal dimension along a direction W parallel to the back of the case) that corresponds to the thickness of a charge card (0.76 mm, 0.030 in) and with a length (its open vertical dimension along the vertical direction L of the case) that corresponds to the width of a charge card (53.98 mm, 2.125 in). That is, the width and depth dimensions are defined according to ISO/IEC 7810 ID-1. The depth of the slot 11 is limited to a few millimeters.

The backwall of the case 1, i.e., its upper part 2, is formed with an insertion pocket 13. The pocket 13 is sized to as to easily accommodate at least one, but preferably two, or even more cards of the ID-1 dimension (85.60×53.98×0.76 mm; 3.370×2.125×0.030 in). These are charge cards, such as credit cards and debit cards, ATM cards, and also modern ID cards, driver license cards, passport cards, and the like. This, accordingly, is the meaning of the “general dimensions of a credit card.”

The pocket 13 has a tong lip 14, which is disposed to securely hold the card inside the pocket 13. The tong lip 14 is a spring which springs back, away from its opposing wall by at least one thickness dimension, but preferably by two, or even more thickness dimensions of the card. The maximum required spring-back, of course, is the open width of the insertion slot 13 at the top of the backwall. The card, once inserted, is partly exposed in a window 15, by way of which the card can be slid upwardly and partly out of the pocket slot 13.

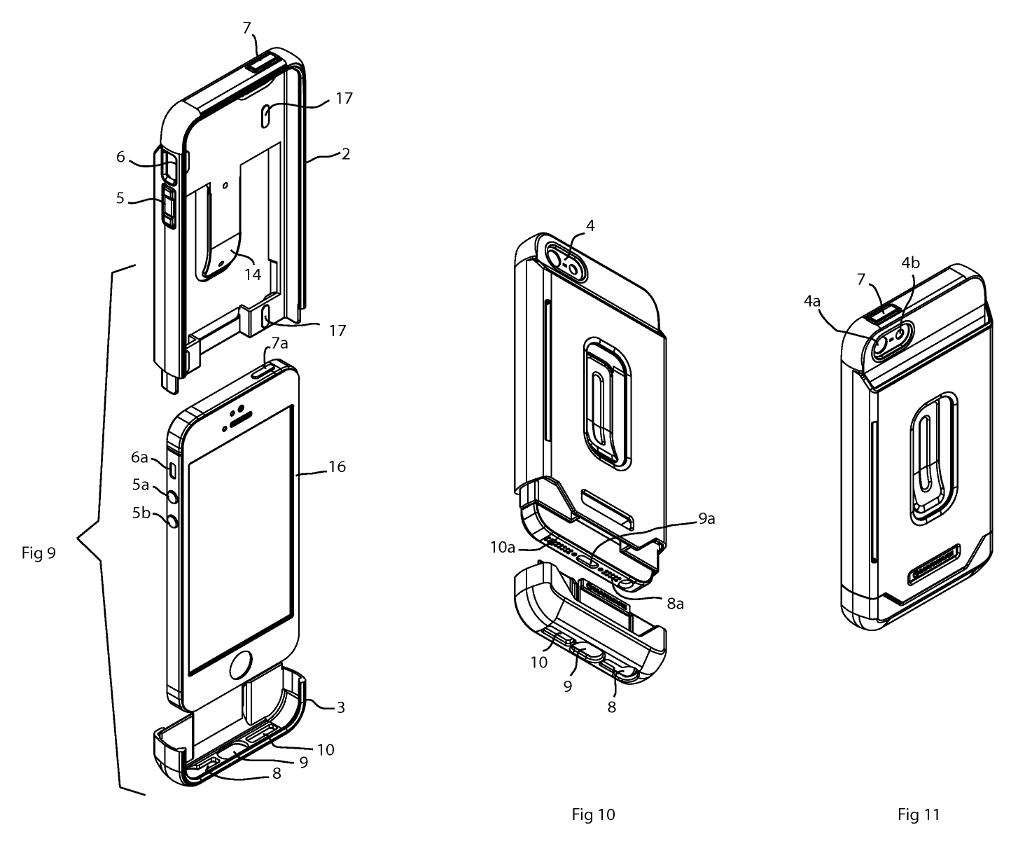

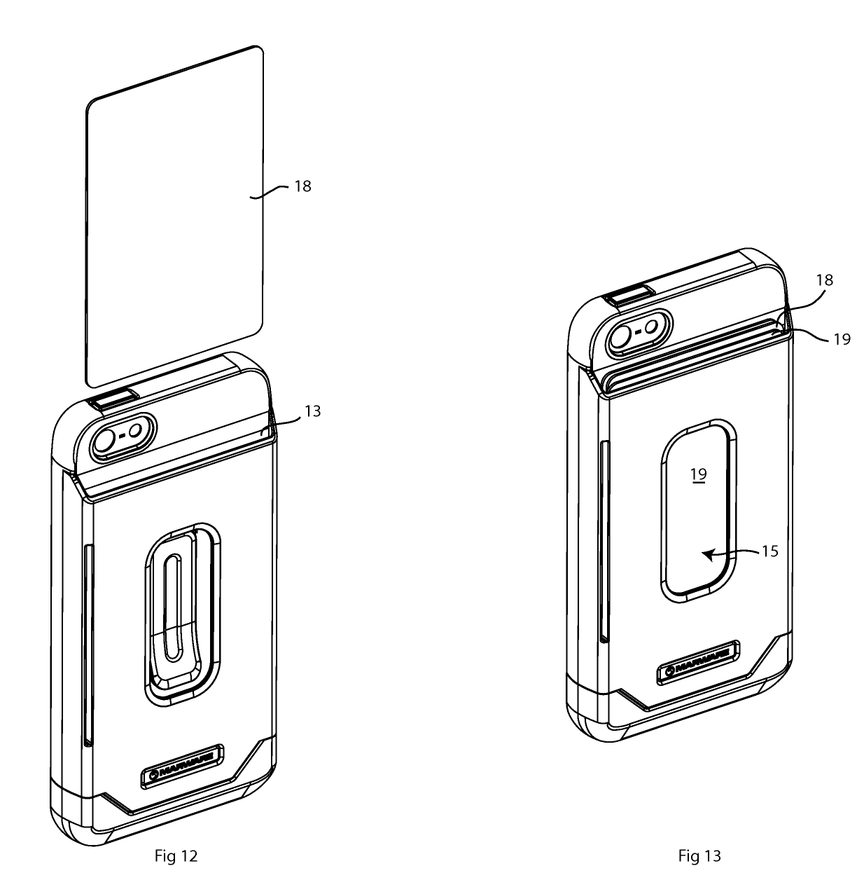

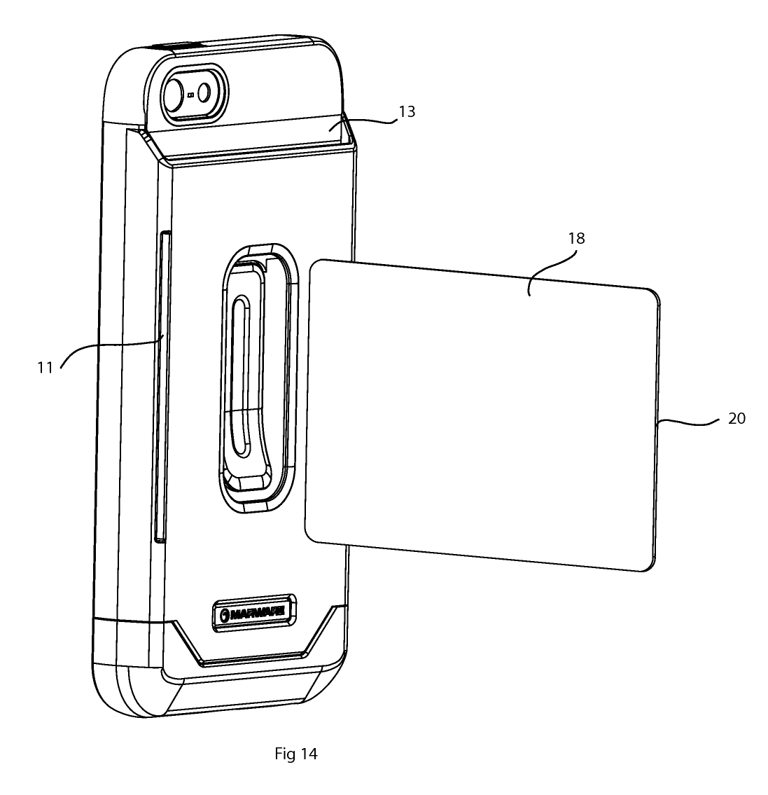

Turning now to FIGS. 9, 10, and 11, there is shown the device together with an iPhone® 16 in various stages of assembly. In FIG. 9, the case is shown in an exploded view. As can be seen, The toggle button 5 is aligned with a volume increase button 5a and with a volume decrease button 5b, the opening 6 is aligned with the ringer on/off switch 6a, and the button 7 is aligned with the ON/OFF button 7a. Similarly, the openings 8, 9, 10 are aligned with the corresponding data and supply ports 8a, 9a, 10a of the phone. Similarly, the opening 4 is aligned with the camera lens 4a and the flash 4b.

The backwall of the case is formed with four support knobs 17 on which the phone is supported when the case is assembled with the phone 16.

Referring now to FIGS. 12-18, there are illustrated a variety of useful positions and utilitarian aspects of the invention. In FIG. 12, a card 18 (i.e., charge card, ID card, etc.) is ready for insertion into the pocket 13. In FIG. 13, the card 18 and two additional cards are inserted into the pocket. As can be seen, one of the cards in the pocket is slightly smaller than the other two. It may be, for example, a business card 19 or the like. The card 19, or any of the cards 18, are partly exposed in the window 15. The outermost such card, i.e., the exposed card, can be pushed upward with a finger until it may be removed from the pocket 13.

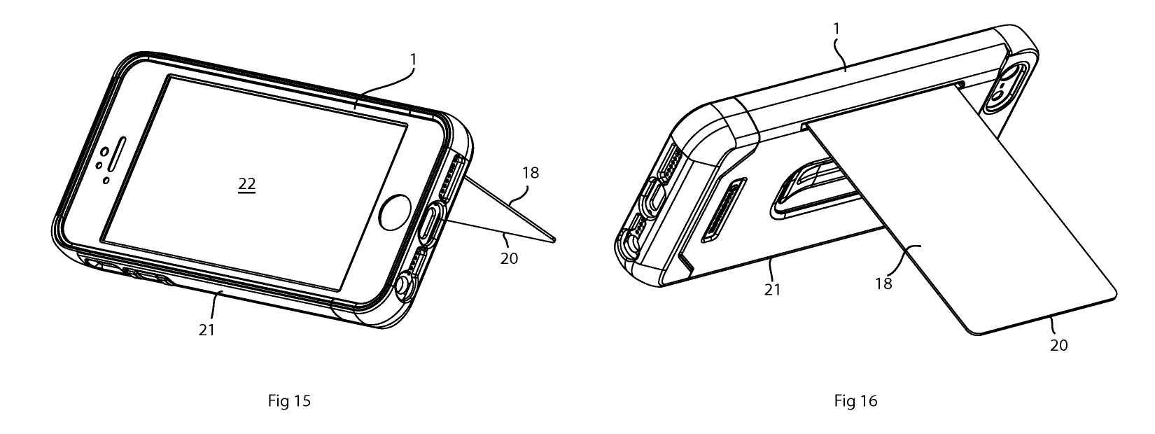

FIGS. 15-18 illustrate the device in viewing orientation. The card 18 is inserted into the slot 11. In the “landscape” orientation of FIGS. 15, 16, an outer edge 20 of the card 18 and a rear side edge 21 of the case 1 together form a support for holding the screen 22 of the phone 16 in its landscape orientation.

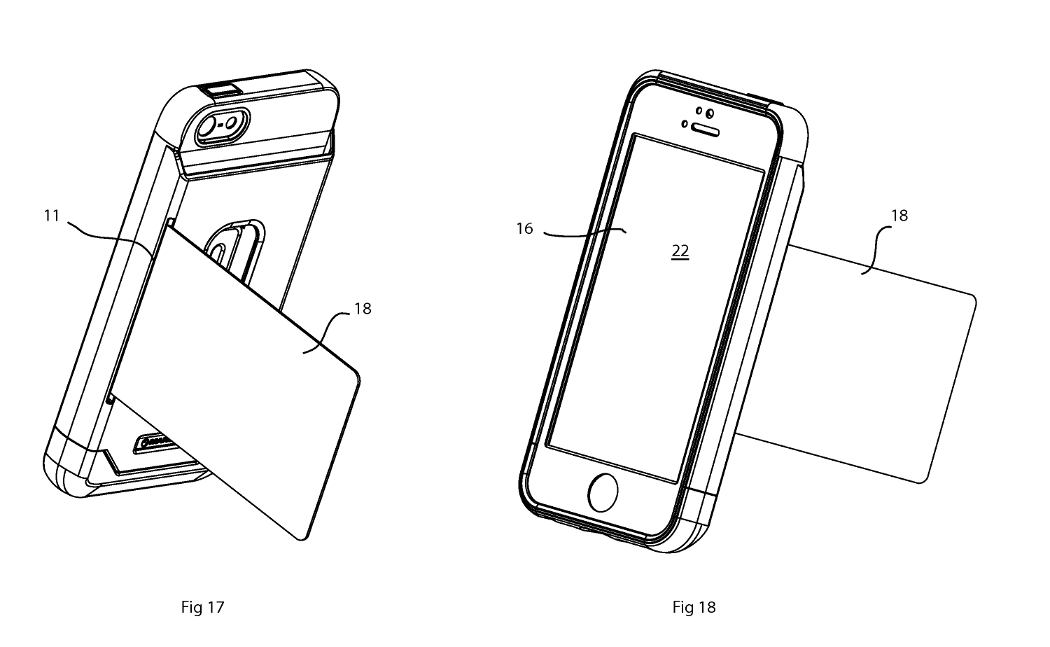

In the “portrait” orientation of FIGS. 17, 18, the outer and lower corner of the card 18 forms one support point of a tripod. The other two support points are formed along the rear/bottom edge of the lower part 3 of the case 1. Again, this is a relatively stable support for the device, with the viewing screen 22 in its portrait orientation.

1. A smartphone case, comprising:
an upper part configured to at least partly cover a rear and sides of an upper portion of a smartphone;
a lower part configured to at least partly cover a rear and sides of a lower portion of the smartphone and configured to connect to said upper part and, in an assembled condition together with said upper part, to form a protective case for the smartphone;
at least one of said parts defining a pocket dimensioned for receiving and housing a card having general dimensions of a credit card; and
at least one of said parts having a slot configured for partial insertion of the card in a direction substantially perpendicular to a rear wall of the smartphone.

2. The mobile telephone case according to claim 1, wherein a front of the smartphone remains substantially exposed in the assembled condition of the case.

3. The mobile telephone case according to claim 1, wherein said slot is formed such that, when the card is inserted, the card supports the smartphone with the front in a substantially upright position.

4. The mobile telephone case according to claim 3, wherein the card supports the smartphone selectively in a landscape orientation and in a portrait orientation.

5. The mobile telephone case according to claim 1, wherein said pocket is dimensioned for receiving a plurality of cards therein.
